(19) United States
(12) Patent Application Publication
(10) Pub. No.: US 2008/0196589 A1
(43) Pub. Date: Aug. 21, 2008

(54) Gas Separating and/or Purifying Gel and Associated Devices

(75) Inventor: Jean-Luc Quere, Eysines (FR)

Correspondence Address: DAVIS BUJOLD & Daniels, P.L.L.C., 112 PLEASANT STREET, CONCORD, NH, 03301, US

(73) Assignees: Jean-Luc QUERE, Eysines (FR); FINERCOR SA, Playa San Juan, Alicante (ES); BREVETS ASSOCIES, Levallois Perret (FR)

(21) Appl. No.: 11/912,074

(22) PCT Filed: Apr. 20, 2006
(86) PCT No.: PCT/FR2006/050365

§ 371 Date: May 7, 2008

(30) Foreign Application Priority Data
Apr. 20, 2005 (FR) 05 51001

(51) Int. Cl. B03C 1/00; C08F 251/00; B01J 13/00

(52) U.S. Cl. 96/2; 96/1; 516/98; 527/300

(57) ABSTRACT

The invention relates to a gel for separating and/or purifying a gas mixture comprising a metal cation, a porous support, a gelling agent and a solvent. Associated devices are also disclosed.

This application is a national stage completion of PCT/FR2006/050365 filed Apr. 20, 2006 which in turn claims priority from French patent application serial no. 05 51001 filed Apr. 20, 2005.

### FIELD OF THE INVENTION

The present invention concerns a gel for the separation and/or purification of gases as well as the associated devices.

### BACKGROUND OF THE INVENTION

The separation and purification of gases is of fundamental interest in numerous industrial fields. Gas separation makes it possible to obtain raw materials essential to the chemical industry (di-nitrogen, di-hydrogen, di-oxygen, etc.) or for the medical fields that use large quantities of di-oxygen.

Gas separation it makes it possible to avoid discharging polluting mixtures including gases harmful to the environment as well as gases that can be upgraded differently provided they can be separated and recovered under favorable economic and industrial conditions.

### SUMMARY OF THE INVENTION

Known gas purification processes include the PSA (Pressure Swing Adsorption) or the TSA (Temperature Swing Adsorption) processes, which use zeolite-based absorption beds, notably for the purification of di-nitrogen and di-oxygen derived from the air.

The zeolites are porous and are selected to capture certain specific cations by ionic interaction.

Thus, by passing a gaseous mixture through a succession of several types of zeolite, certain types of gaseous molecules can be retained, and it is possible in the end to obtain a purified gas, that to a very large extent contains a single type of molecule.

By manipulating the pressure and/or the temperature of the initial conditions, the above-mentioned processes first make it possible to produce or to reinforce the selectivity and retention power of the zeolites used, and then to secluded the retained gaseous molecules.

The processes are complex as are the devices necessary for their implementation. An illustration of this is provided in European patent no. EP 349 655.

Other existing technologies make use of gels, including ion exchange materials for extracting ions such as is described in U.S. Pat. No. 3,284,238.

U.S. Pat. No. 4,284,726 discloses a composition of a gel for capturing anions and U.S. Pat. No. 5 4,797,366 describes a gas treatment process for extracting hydrogen sulfide H₂S by means of a cation exchange resin.

None of these processes allow the use of a simple industrial procedure that can potentially work continuously.

### BRIEF DESCRIPTION OF THE DRAWINGS

The present invention is now described in detail according to specific examples of the embodiments. Drawings are appended, and the different figures represent:

FIG. 1: a diagram of a passive separation device;

FIG. 2: a diagram of a variant of the passive separation device of FIG. 1, with two secondary outlets;

FIG. 3: a diagram of an active separation device; and

FIG. 4; a diagram of a device with continuous regeneration.

### DETAILED DESCRIPTION OF THE PREFERRED EMBODIMENTS

The process according to the invention includes causing a flow of a gaseous mixture to circulate through a gel, permitting the separation and/or the purification of a specific gaseous molecule.

This gel comprises a metal cation, a porous support, a gelling agent, and a solvent.

The metal cation used can be mono-, di- or trivalent and also mono- or poly-atomic.

The following cations can be cited: Li⁺; Na⁺ Cu⁺; Ag⁺; Ca²⁺; Fe²⁺; Cu²⁺; Mg²⁺; Mn²⁺; Co²⁺; Fe³⁺; Al³⁺.

More specifically, the cation Fe²⁺ is used.

The cation concentration is determined as a function of the volume of gel and the flow of gas passing through it and the affinity of the cation for the gas molecule being targeted. To give an order of magnitude, the concentration is situated between 1 mM (0.03937 in) and 5 M (16.4 ft), more specifically, 10 mM (0.3937 in) and 1 M (3.281 ft).

The porous support can be mineral and/or organic. In the case of resin-based organic supports, the cation exchange groups are grafted, for example, by covalence, whereas in the case of mineral supports, the active elements such as zeolites consisting of aluminosilicate crystals are integrated into the support itself.

A quantity of porous support ranging between 10 and 80% by weight of the gel, and more specifically, between 30 and 60%, is used.

One embodiment comprises a porous support with silica balls and a cationic resin.

The gelling agent can be comprised of the porous support itself in the case of resins. However, this gelling agent is generally distinct from the porous support.

This gelling agent is preferably chosen from among polysaccharides, carrageenans, alginates, pectins, cellulose, glycogen, starch and polymer resins. Agarose is a preferred gelling agent.

The concentration of gelling agent must allow for the cohesion of the porous support but still allow the gaseous flow to circulate through the porous support.

The order of magnitude of the values of the gelling agent is between 0.01 and 80% by weight of the gel, and preferably between 0.05 and 0.2%.

The solvent used is a polar or apolar protic or aprotic solvent compatible with the porous support/gelling agent couple. More specifically, the solvent is polar and protic.

Water, alcohols such as glycerol, methanol and ethanol may be chosen.

The quantity of solvent is related to the consistency of the gel to be obtained as a function of the nature of the gel used, since the flow of gas must be able to circulate through it.

To establish an order of magnitude, the quantity of solvent is between 5 and 90% by volume compared to the gel, and more specifically, between 25 and 75%.

According to one improvement, the medium includes an acid in solution to avoid oxidation of the metal cations used, thus maintaining the pH between 1 and 6. This acid must be compatible with the porous support/gelling agent couple used. This acid can be tartaric, hydrochloric, sulfuric, methanoic or acetic acid.

The invention also covers an associated device including this gel to separate and/or purify a gaseous mixture and to extract from it at least a portion of the specific gaseous molecules.

Reference to the various figures is made to clarify these points.

The device consists of a container 10 in which is placed a gel 12 according to the present invention as it has just been described.

This container 10 is equipped with an inlet 14 for the gaseous mixture to be treated, a primary outlet 16 equipped with a pump 18, and with at least one secondary outlet 20, also equipped with a pump 22.

The pump 18 of the primary outlet 16 has a flow D greater than that of flow d of pump 22 of secondary outlet 20.

The device operates as follows: the gaseous mixture at inlet 14 is made to pass through the gel according to the invention by the vacuum created by the pumps.

This gel has a composition that is suitable for retaining certain gaseous molecules as indicated previously, for example, carbon monoxide, carbon dioxide or carbon disulfide, contained in the initial mixture.

Thus, the proportion of this molecule retained by the gel decreases in the gaseous composition collected at secondary outlet 20.

The gaseous composition at this secondary outlet 20 is purified by the extraction of a proportion of this specific molecule retained by the gel.

The flow ratio D/d must be adapted as a function of the gel, the gaseous mixture and the affinity and retention power of the gel for the gaseous molecule. A ratio of between 5/1 and 25/1 is preferable.

The flow must be adapted so as not to cause the disassociation of the metal cation/fixed gaseous molecule complex bond.

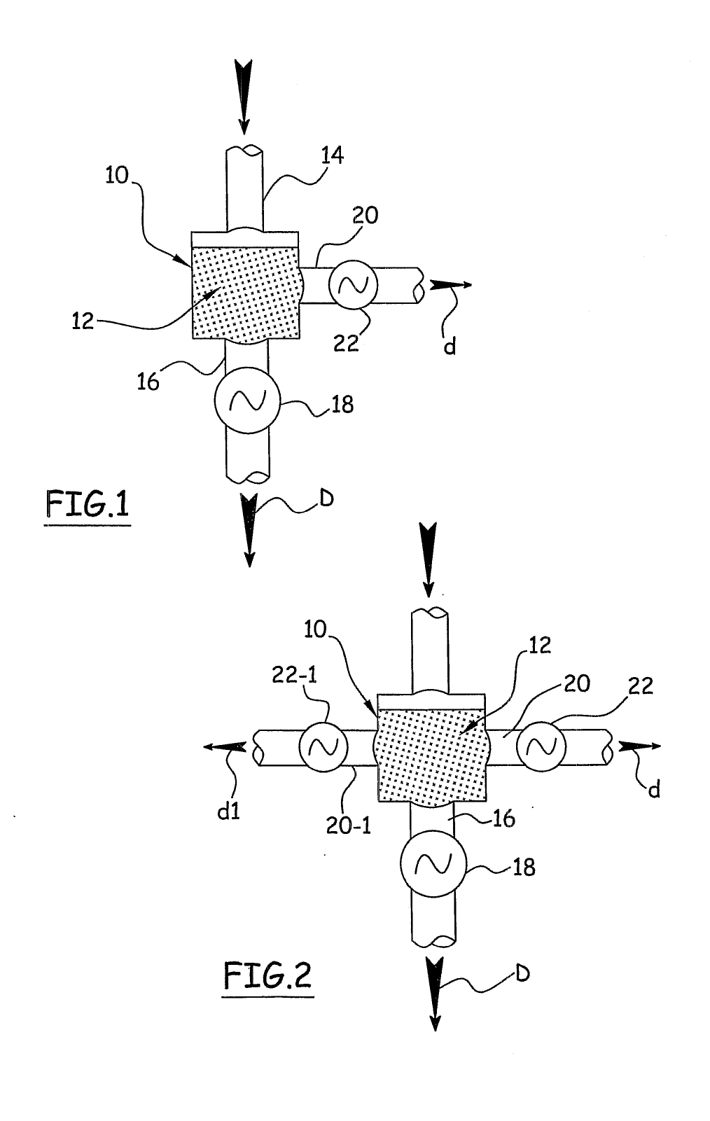

According to an improvement represented in FIG. 2, a supplementary secondary outlet 20-1 is provided, equipped with a pump 22-1.

The flow d1 of this pump 22-1 must also be less than D.

Preferably, the flow d1 will be identical to d.

A successive series of such devices can also be produced, with the outlet of one being the inlet of the next one.

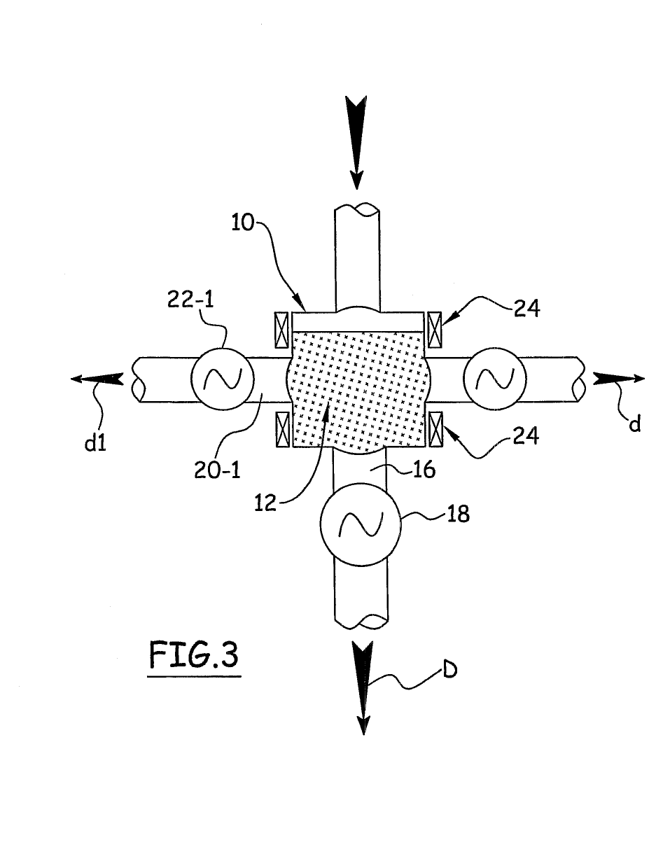

According to an improved embodiment variation represented in FIG. 3, two magnets 24 are attached to the periphery of container 10, and the gel used includes ferrous ions.

The magnet is positioned so that its magnetic field is oriented toward secondary outlet 20.

The magnet is preferably an electromagnet so that the magnetic field generated can be modified and thus dynamically modify the efficiency of separation.

In fact, in this way, it is possible to fix the gaseous molecule temporarily in the gel via the ferrous ions, reorient it and provoke a preferential separation according to the magnetic field, which would cause an increase in the proportion of the gaseous molecule in the flow of gas at secondary outlet 20, and thus a depletion of the main flow, which would be at least partially purified of this molecule.

As in the previous case, this mode of embodiment of a device incorporating a magnetic field can be multiplied, set up in series, and may include one or more secondary outlets.

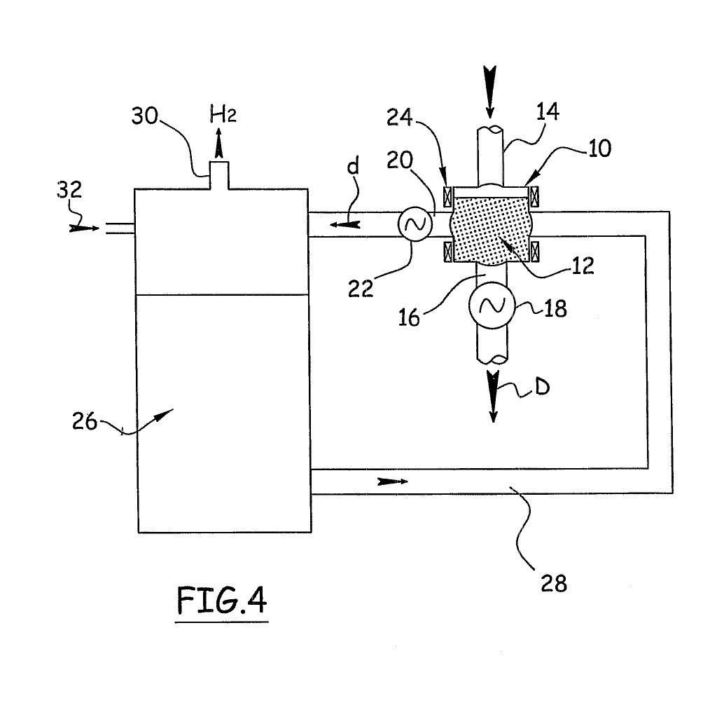

In FIG. 4, the configuration represented allows for an improvement with the recycling of the gas from the secondary outlet, thus preventing any saturation by the retained gaseous molecule.

In an example designed to treat a flow of gas containing CO₂, a gel with Fe²⁺ is used and the solvent is water.

A treatment tank 26 and a closed circuit 28 for the flow of the secondary circuit are provided. This tank 26 contains iron in metal form as catalyst. This tank includes a gas outlet 30 and a water feed 32.

The device allows the capture of CO₂ molecules that are at least in part dissolved in the gel and evacuated via the secondary outlet.

These CO₂ molecules in contact with water produce H₂CO₃ which decomposes into HCO₃⁻ and H⁺.

In the presence of Fe²⁺ cations, the HCO₃⁻ anions are transformed into an [HCO₃Fe]⁺ complex with precipitation of FeCO₃ and release of H⁺ ions.

In the presence of metallic iron, these H⁺ ions form Fe²⁺ ions and di-hydrogen, which is recovered at outlet 30. These H⁺ ions can also combine with HCO₃— to form carbon dioxide, which is also recovered.

The type of reaction depends on the operating conditions, and particularly the pH.

The device according to the invention including the gel according to the invention allows the purification of a gaseous composition by extracting at least a portion of the specific gaseous molecules that are to be removed from this gaseous composition, such as, in this case, nitrogen dioxide.

In addition, it is noted that hydrogen can also be produced.

Examples are given below to illustrate the invention.

(1) Preparation of a Separating Gel:

The following composition is prepared:
40 g (1.411 oz) of silica gel 60,
40 g (1.411 oz) of negatively charged AVICEL ion exchange resin,
19.5 g (0.6878 oz) of tartaric acid,
36.1 g (1.273 oz) of heptahydrated ferrous sulfate II (FeSO₄), and
100 ml (6.102 in³) of water.

The composition is maintained at 100° C. (212° F.) while stirring to ensure the dissolution of the tartaric acid and of the ferrous sulfate.

The gelling agent, in this case 0.1 g (0.003527 oz) of agarose, is dissolved in 100 ml (6.102 in³) of water at 100° C. (212° F.), maintained at this temperature until complete dissolution, and this dissolved gelling agent is added to the composition.

This complete composition is then homogenized and dehydrated.

This powder allows the production of the gel according to the invention by the addition of a volume of water to a volume of powder.

(2) Example of the Purification of a Water/Gaseous Mixture Containing Carbon Monoxide and Carbon Dioxide with this Gel and a Passive Device.

10 g (0.3527 oz) of separating gel thus prepared are distributed in a cylindrical volume, 2 cm (0.7874 in) in diameter by 6 cm (2.362 in) in height.

The passive device is the simple mode of the embodiment shown in FIG. 1.

A flow D of 24.5 l/min (0.8652 ft³/min) and a flow d of 1.166 l/ml (0.04118 ft³/min) are used.

The main gas injected contains both 4.87% CO₂ and 419.1 ppm CO with, in addition, di-nitrogen and di-oxygen.

The analyses continue for a period of 10 min. The following results are obtained:

| | |
|---|---|
| WITHOUT GEL | WITH GEL |

| | Primary | Secondary | Primary | Secondary |
|---|---|---|---|---|
| Concentration | 4.87 | 4.87 | 3.94 | 0.04 |
| of CO₂% | | | | |
| Concentration | 419.1 | 419.1 | 376.17 | 20.91 |
| of CO(PPM) | | | | |

We note in the presence of the gel, a purification of the gas with a concentration of 81.8% for the carbon dioxide only compared to the incoming flow, and a concentration of 95% for the carbon monoxide only, still with respect to the incoming flow.

This is explained by the significant solubility of the monoxide/carbon dioxide in the gel itself.

The distribution between the primary and secondary outlets is interesting, because it shows that the secondary outlet comprises a very small fraction of each of the two gases. This might be explained by the fact that the affinity between the ferrous ions and the monoxide/carbon dioxide is enough to induce a bond that is sufficiently resistant to the vacuum of the secondary outlet 20 with a lesser flow rate, and insufficiently resistant to the strong vacuum at the primary outlet 16. This therefore modifies the distribution between the outlets.

In fact, the gaseous flow at the secondary outlet is very highly purified.

(3) Purification of a Gas Flow Containing Traces of Carbon Disulfide with a Gel Obtained According to (1) and a Passive Device.

The same quantity of gel is used with an identical container.

Carbon disulfide CS₂ concentration of the gaseous mixture at the inlet: 500 ppb.

Primary flow D: 20 l/min (0.7063 ft³/min) and secondary flow d: 4 l/min (0.1413 ft³/min).

Duration 1 minute for 30 l (1.059 ft³) of gaseous mixture treated.

| | |
|---|---|
| WITHOUT GEL | WITH GEL |

| | Primary | Secondary | Primary | Secondary |
|---|---|---|---|---|
| Concentration | 500 | 500 | 75 | 0 |
| of CS₂ in ppb | | | | |

We note first of all that the disulfide is dissolved in the gel water so the main flow contains only 15% carbon disulfide.

Then the strong affinity of the carbon disulfide molecule for the gel inhibits any movement towards the secondary, very low flow outlet.

A gas is thus obtained at the secondary outlet that is totally purified, free of carbon disulfide.

(4) Example Identical to that of (3) with an Active Device as Represented in FIG. 3.

In this case, the carbon disulfide is even eliminated from the primary outlet, because the affinity between the gel and the molecules of carbon disulfide is too strong for even the significant flow D at the primary outlet to be sufficient.

We note that as a result of the gel according to the invention and the device for its implementation, it is possible to separate and/or purify a gaseous mixture under industrial conditions.

1-9. (canceled)

10. A gel for at least one of separation and purification of a gaseous mixture, the gel comprising of:
a metal cation,
a porous support,
a gelling agent, and
a solvent.

11. The gel for at least one of separation and purification of the gaseous mixture according to claim 10, wherein the metal cation is at least one of monovalent, divalent, trivalent, monoatomic and polyatomic.

12. The gel for at least one of separation and purification of the gaseous mixture according to claim 11, wherein the metal cation is selected from the group consisting of: Li⁺; Na⁺ Cu⁺; Ag⁺; Ca²⁺; Fe²⁺; Cu²⁺; Mg²⁺; Mn²⁺; Co²⁺; Fe³⁺; and Al³⁺.

13. The gel for at least one of separation and purification of the gaseous mixture according to claim 10, wherein the gelling agent is selected from the group consisting of: polysaccharides, carrageenans, alginates, pectins, cellulose, glycogen, starch and polymer resins.

14. The gel for at least one of separation and purification of the gaseous mixture according to claim 10, wherein the solvent is at least one of water and alcohol.

15. A device for at least one of separation and purification of the gaseous mixture, the device comprising:
a gel comprising a metal cation, a porous support, a gelling agent, and a solvent;
a container (10) for containing the gel (12);
an inlet (14) in the container (10) through which the gaseous mixture is introduced into the container (10);
a primary outlet (16) in the container (10), which is coupled to a first pump (18) to withdraw at least a portion of the gaseous mixture from the container (10) via the primary outlet (16); and
at least one secondary outlet (20) in the container (10), which is coupled to a second pump (22) to withdraw at most an other portion of the gaseous mixture from the container (10) through the at least one secondary outlet (20).

16. The device for at least one of separation and purification of the gaseous mixture to claim 15, further comprising at least one magnet (24) on a periphery of the container (10) and the metal cation includes ferrous ions.

17. The device for at least one of separation and purification of the gaseous mixture according to claim 16, wherein the magnets (24) are electromagnets.

18. The device for at least one of separation and purification of the gaseous mixture according to claims 15, further comprising a treatment tank (26) coupled to the container (10) by a closed circuit (28), the at least one secondary outlet (20) is coupled to the closed circuit (28) such that the other portion of the gaseous mixture is directed to the treatment tank (25) for recycling to avoid any saturation by retained molecules of the gaseous mixture.
